(19) United States
(12) Patent Application Publication
(10) Pub. No.: US 2010/0121665 A1
(43) Pub. Date: May 13, 2010

(54) CALENDAR AVAILABILITY ASSESSMENT

(75) Inventor: John M. Boyer, Victoria (CA)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/267,807

(22) Filed: Nov. 10, 2008

(51) Int. Cl. G06Q 10/00

(52) U.S. Cl. 705/8

(57) ABSTRACT

A method for an electronic calendar and scheduling application to associate levels of availability (bookability) with time slots on individual calendars for minimizing the level of intrusiveness during the scheduling of a meeting includes: determining a set of feasible time slots bounded by a time range; determining a time slot with the lowest level of intrusiveness for one or more potential participants by: determining a level of intrusiveness in a time slot by: assigning a first weight based on a participant's attendance level to the meeting; assigning a second weight based on a participant's booking availability priority; performing a mathematical calculation with the first weight and second weight to obtain a calculated value; storing the calculated value; obtaining additional calculated values for additional participants; and wherein in the event there are no more additional participants: performing a mathematical combination of the stored calculated values to obtain an intrusiveness value.

### BACKGROUND

This invention relates generally to electronic scheduling software, and more particularly to providing a method and system for an electronic calendar and scheduling application that associates levels of availability (bookability) with time slots on individual calendars for minimizing the level of intrusiveness during the scheduling of a meeting.

Electronic calendar and scheduling programs have become a central feature of modern life and have become quite prevalent in and out of the work environment. For example, during the course of one day of travel, a user may utilize an electronic calendar and scheduling application at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day. The widespread use of electronic calendar and scheduling applications has increased the demands for improved features, ease of use, and enhanced productivity solutions.

### SUMMARY

Embodiments of the present invention include a method, article, and system for an electronic calendar and scheduling application to associate levels of availability (bookability) with time slots on individual calendars for minimizing the level of intrusiveness during the scheduling of a new meeting in a time slot, the method includes: determining a set of feasible time slots bounded by a time range; determining a time slot, from the set of feasible time slots, with the lowest level of intrusiveness for one or more potential participants by: determining a level of intrusiveness in a time slot by: assigning a first weight based on a participant's attendance level to the meeting; assigning a second weight based on a participant's booking availability priority; performing a mathematical calculation with the assigned first weight on the participant's attendance level and the assigned second weight on the booking availability priority to obtain a calculated value; storing the calculated value; determining whether there are additional participants; wherein in the event there are additional participants: obtaining an additional calculated value for each additional participant using the process steps outlined above; and wherein in the event there are no more additional participants: performing a mathematical combination of the stored calculated values to obtain an intrusiveness value that indicates a level of scheduling conflict in the time slot; and wherein from the set of feasible time slots, the time slot with the lowest intrusiveness value is used for scheduling the new meeting.

An article comprising one or more computer-readable storage media containing computer readable instructions that, when executed by a computer enables a method for implementing an electronic calendar and scheduling application to associate levels of availability (bookability) with time slots on individual calendars for minimizing the level of intrusiveness during the scheduling of a new meeting in a time slot, the method includes: determining a set of feasible time slots bounded by a time range; determining a time slot, from the set of feasible time slots, with the lowest level of intrusiveness for one or more potential participants by: determining a level of intrusiveness in a time slot by: assigning a first weight based on a participant's attendance level to the meeting; assigning a second weight based on a participant's booking availability priority; performing a mathematical calculation with the assigned first weight on the participant's attendance level and the assigned second weight on the booking availability priority to obtain a calculated value; storing the calculated value; determining whether there are additional participants; wherein in the event there are additional participants: obtaining an additional calculated value for each additional participant using the process steps outlined above; and wherein in the event there are no more additional participants: performing a mathematical combination of the stored calculated values to obtain an intrusiveness value that indicates a level of scheduling conflict in the time slot; and wherein from the set of feasible time slots, the time slot with the lowest intrusiveness value is used for scheduling the new meeting.

A system for an electronic calendar and scheduling application, the system includes: one or more computing and communication devices in communication through a network; wherein the one or more computing and communication devices are configured to: determine a set of feasible time slots bounded by a time range; determine a time slot, from the set of feasible time slots, with the lowest level of intrusiveness for one or more potential participants by the following: determine a level of intrusiveness in a time slot by the following: assign a first weight based on a participant's attendance level to the meeting; assign a second weight based on a participant's booking availability priority; perform a mathematical calculation with the assigned first weight on the participant's attendance level and the assigned second weight on the booking availability priority to obtain a calculated value; store the calculated value; determine whether there are additional participants; wherein in the event there are additional participants: obtain an additional calculated value for each additional participant using the process steps outlined above; and wherein in the event there are no more additional participants: perform a mathematical combination of the stored calculated values to obtain an intrusiveness value that indicates a level of scheduling conflict in the time slot; and wherein from the set of feasible time slots, the time slot with the lowest intrusiveness value is used for scheduling the new meeting.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart of an intrusiveness algorithm according to embodiments of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

Electronic calendar and scheduling programs and software products are configured for the effective time management of users. Currently, calendar and scheduling systems provide users with an ability to list all required and optional participants for a meeting, and subsequently the availability of the selected meeting participants is displayed for the date/time slot chosen. An overall indication of a participant's availability may be given as well, such as red if there is a conflict and green otherwise. Each participant's availability is indicated as unavailable if they have a conflicting booking or available otherwise.

A logistical problem that occurs for many busy individuals is that other people within an organization attempt to schedule (book) meetings in all the time slots that appear to be “available” during a day, leaving little or no time for performing the action items that are generated in those meetings. The resultant lack of available work time that falls outside of meetings often causes busy individuals to start scheduling time into their calendars to do these work items. However, these scheduled work time bookings are indistinguishable from actual meetings with other people, leading to the appearance of unavailability for potentially important meetings. The ‘find next available time’ feature, of calendar and scheduling programs, very often puts meetings too far out in time in a schedule, so a person scheduling a meeting will ultimately ignore the non-availability status reported by the calendar and scheduling program in order to schedule their meeting in a reasonable time frame. In this instance, individuals who are available accept the newly scheduled meeting, possibly after rescheduling other conflicting events or meetings. However, often there is a required person who cannot make the newly scheduled meeting, due to a conflicting scheduled event of higher priority. In this instance the new meeting has to be rescheduled, possibly multiple times and despite the earlier efforts of others to accommodate the time. Therefore, a better solution is required to balance the need to schedule meetings while taking into account the individual requirements of the meeting participants.

Embodiments of the invention provide a method and system for associating levels of availability (bookability) with time slots on an individual's calendar. Embodiments of the invention not only indicate whether a time slot is free or booked, but also provide visual indicators, such as a color or pattern coding scheme, and an underlying algorithm that is used to indicate the level of urgency associated with a booked time slot.

Embodiments of the invention provide a means for an individual during a scheduling process to more reasonably decide whether to request a double-booking of a selected participant whose time is already booked. The decision to double-book is based on the visual indicators and their underlying algorithms.

Embodiments of the invention provide additional flexibility in a ‘find next available time’ feature to a user. With embodiments of the invention, a user may ‘find the least intrusive time within the next N days’. Within that time frame, there may be no times in which a double-booking may be avoided, but there may be time slots where little or no double-bookings occurs across an urgent booking, as displayed to the user with the visual indicators. Moreover, the urgent double-bookings may only apply to optional participants of the new meeting, and thereby would not preclude the user from adding the meeting to the schedule. The ability of a user to express a time limit within which the least intrusive meeting time must be found (e.g., the next N days), the user is implicitly given the ability to express a level of urgency for scheduling an event or meeting, where a shorter time limit implies greater urgency. In other words, a meeting's level of urgency is inversely proportional to the period of time available to schedule the meeting. A greater sense of urgency is attributed to an event where the user has specified a shorter date/time range in which to schedule the event in a time slot. Alternately, the user may be allowed to select a level of urgency for the event, where the level of urgency selected corresponds to the selection of a date/time range. For example, levels of urgency for an event may be “open” (pick next available unintrusive time slot), “low” (pick least intrusive time slot within one month), “medium” (pick least intrusive timeslot within one week), “high” (pick least intrusive time slot this week), and “very high” (pick least intrusive time slot today).

In embodiments of the invention, two types of bookings are recognized: meeting bookings that involve other participants, and task bookings for performing an action item or task by an individual alone. Both types of bookings may be assigned one of three levels of priority: high, normal, and low. For example default values may be specified as follows: a low priority for an optional meeting booking; a normal priority for a required meeting; a high priority for an essential meeting; and a normal priority assigned for a task booking. For a task booking, a user may select a priority other than the default. For example, a high priority would be selected for an urgent task with a short deadline or a harder task with a longer deadline. A low priority could be assigned to a task that has to be done, but can more easily be deferred, such as a software update.

In a meeting booking, according to embodiments of the invention, a participant may be categorized as optional, required, or essential. An optional participant may be a spectator, while a required participant may be a decision maker, and an essential participant a presenter or meeting moderator. A meeting organizer may select priorities other than the defaults for the classes of meeting participants. For example, an urgent meeting could assign a high priority to required attendees and normal priority to optional attendees. In addition, during an acceptance of a meeting booking, a participant may change their assigned priority for the meeting booking. For example, an optional invitee may feel the meeting is urgent if, for example, it relates to an urgent task.

In embodiments of the invention, the meeting organizer specifies the optional, required, and essential participants for a meeting booking, and a calendar check may be performed. For each participant, a simple visual coding, such as a color or pattern, may be used to indicate a participant availability. In an exemplary embodiment the color-coding may use green for available, yellow for a low priority booking, orange for a normal priority booking, and red for a high priority booking.

For a meeting booking in embodiments of the invention, a meeting organizer may be given the option of requesting the least intrusive meeting within a given timeframe. An algorithm for determining intrusiveness takes into account the date/time range from which feasible time slots must be selected, the attendance level of each participant (optional, required, essential), and the availability of each participant in the feasible time slots.

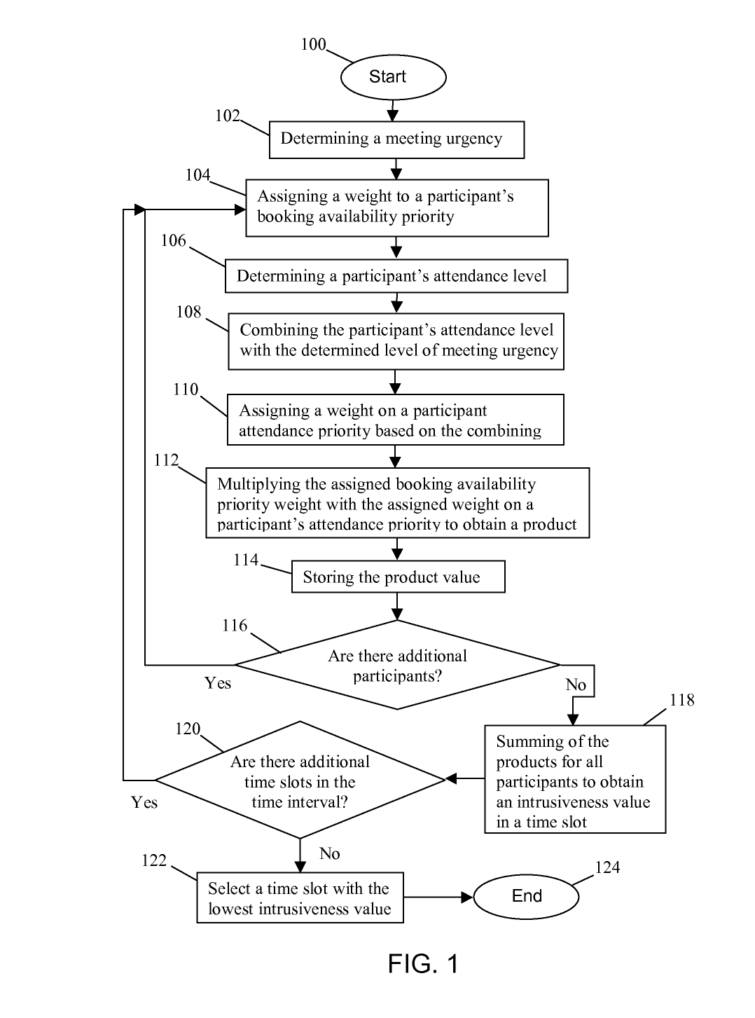

FIG. 1 is a flowchart of an intrusiveness algorithm according to embodiments of the invention. The intrusiveness algorithm starts (block 100) by determining a set of feasible time slots (block 102) based on a selected time interval (date/time range) that bounds the feasible time slots. A feasible time slot may denote a time slot that falls within an organization's normal working hours, or when members of a team are normally available to meet. For example, a time interval that includes an interim weekend would have time slots that are not feasible for organizations that do not conduct meetings on the weekend. The process continues with the assigning of a weight on a participant's booking availability priority (block 104) (for example: 0=available, 1=low, 2=normal, 3=high), and determining the participant's attendance level (block 106) (with example weights of 1=optional, 2=required and 3=essential). Subsequently, for each participant, a mathematical calculation for a participant's intrusiveness value that is based on the assigned booking availability priority weight and the assigned weight on a participant's attendance level is made (block 108), and the calculated value is stored for the participant (block 110). The mathematical calculation may involve multiplication or subtraction. In the event there are additional participants (decision block 112 is Yes), calculated values are obtained for each participant (blocks 104-110), until there are no outstanding participants (decision block 112 is No). The calculated intrusiveness value for each of the participants is combined to provide an intrusiveness value for a particular time slot within a selected time date interval (block 114). Subsequently, a determination is made if there are additional feasible time slots in the selected time/date interval (decision block 116). In the event there are additional feasible time slots in the time/date interval to evaluate for an intrusiveness value (decision block 116 is Yes), the process repeats for each participant in the new time slot under consideration. In the event there are no additional feasible time slots to evaluate in the given time/date period (decision block 116 is No), the time slot with the least combined intrusiveness value is selected and suggested as the meeting time by the calendar and scheduling program (block 118), and the process concludes (block 120).

In the event the mathematical calculation (in block 108) is multiplication, a double booking is more harmful if there is a previous booking of a higher priority, and the double-booking is even more harmful if the participant is more essential. In the event the mathematical calculation is a subtraction operation as outlined in the flowchart of FIG. 1, the intrusiveness algorithm determines the intrusiveness of scheduling a meeting or event during a particular time slot based on the sum of intrusiveness values of individual participants, where the level of intrusiveness for an individual participant is not expressed as the product (for a mathematical calculation involving multiplication) of booking availability priority weight and attendance level weight, but as the difference of the booking availability priority weight minus the attendance level weight. In this case, a double-booking is generally deemed more intrusive if there is a prior booking of higher priority and less intrusive if there is no prior booking or a prior booking of lower priority. Thus, the multiplication method measures intrusiveness as the likelihood that either the new booking or a preexisting booking will be rescheduled, whereas the subtraction method places greater emphasis on the rescheduling behavior of the participants. For example, the multiplication method rates a time slot as most intrusive if an essential participant has a preexisting high priority booking in the time slot and hence the new meeting is more likely to be automatically rescheduled to another time slot by the selection method (block 118). In the same example, the subtraction method assigns a neutral intrusiveness to the double-booking since it is equally likely that either the new meeting or the preexisting booking will be rescheduled. Hence it is no more reasonable to reschedule the new meeting than it is to request that the conflicting booking of equal priority be rescheduled. A simple variation on the subtraction method may be used to produce a bias for rescheduling the new meeting that increases with the number of double-bookings on equal priority bookings to help reduce the number of rescheduling acts or declined invitations.

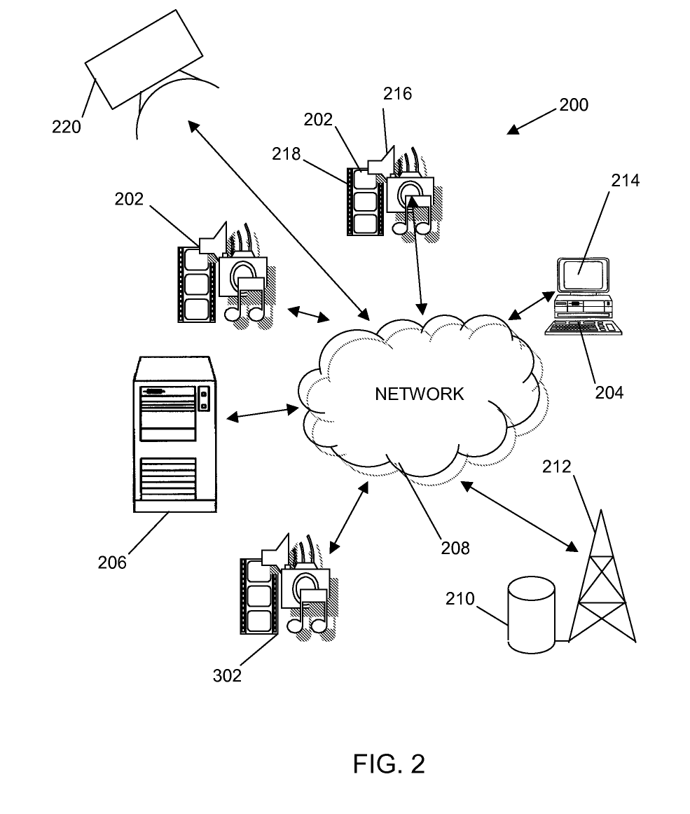

FIG. 2 illustrates an exemplary system 200 for an electronic calendar and scheduling application that associates levels of availability (bookability) with time slots on individual calendars for minimizing the level of intrusiveness during the scheduling of a meeting. The system 200 includes multimedia devices 202, and desktop computer devices 204 configured with display capabilities 214. The multimedia devices 202 may be mobile communication and entertainment devices, such as cellular phones and mobile computing devices that are wirelessly connected to a network 208. The multimedia devices 202 have video displays 218 and audio outputs 216. The multimedia devices 202 and desktop computer devices 204 may be configured with calendar and scheduling software with a graphical user interface (GUI) for implementing embodiments of the invention. The graphical user interface is configured to provide the user with an ability to redefine default values for meeting bookings and task bookings, and to provide visual indicators of time slot booking priorities. The network 208 may be any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 210 and antenna 212.

The calendar and scheduling software of embodiments of the invention may be resident on the individual multimedia devices 202 and desktop computers 204, or stored within the server 206 or cellular base station 210.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

1. A method for an electronic calendar and scheduling application to associate levels of availability with time slots on individual calendars for minimizing the level of intrusiveness during the scheduling of a new meeting in a time slot, wherein the method comprises:
determining a set of feasible time slots bounded by a time range;
determining a time slot, from the set of feasible time slots, with the lowest level of intrusiveness for one or more potential participants by:
determining a level of intrusiveness in a time slot by:
assigning a first weight based on a participant's attendance level to the meeting;
assigning a second weight based on a participant's booking availability priority;
performing a mathematical calculation with the assigned first weight on the participant's attendance level and the assigned second weight on the booking availability priority to obtain a calculated value;
storing the calculated value;
determining whether there are additional participants;
wherein in the event there are additional participants:
obtaining an additional calculated value for each additional participant using the process steps outlined above; and
wherein in the event there are no more additional participants:
performing a mathematical combination of the stored calculated values to obtain an intrusiveness value that indicates a level of scheduling conflict in the time slot; and
wherein from the set of feasible time slots, the time slot with the lowest intrusiveness value is used for scheduling the new meeting.

2. The method of claim 1, wherein the time range that bounds the set of feasible time slots is determined by an inversely proportional relationship to a level of urgency associated with the new meeting.

3. The method of claim 1, wherein the mathematical calculation is multiplication.

4. The method of claim 1, wherein the mathematical calculation is a subtraction; and
wherein the assigned first weight on the participant's attendance priority is subtracted from the assigned second weight on the booking availability priority.

5. The method of claim 1, wherein the mathematical combination is a summation.

6. The method of claim 1, wherein the assigned first weight on a participant's attendance level is determined using ascending numeric values associated with one of the following sequences of qualifiers:
optional, required, and essential; and
spectator, decision-maker, and presenter/moderator.

7. The method of claim 1, wherein the assigned second weight value differs for a participant that is available and not scheduled for a conflicting meeting in the time slot, an optional participant in a conflicting meeting in the time slot or has a low priority booking in the time slot, a required participant in a conflicting meeting in the time slot or has a normal priority booking in the time slot, and an essential participant in a conflicting meeting in the time slot or has a high priority booking in the time slot.

8. An article comprising one or more computer-readable storage media containing computer readable instructions that, when executed by a computer, performs a method for implementing an electronic calendar and scheduling application to associate levels of availability with time slots on individual calendars for minimizing the level of intrusiveness during the scheduling of a new meeting in a time slot, wherein the method comprises:
determining a set of feasible time slots bounded by a time range;
determining a time slot, from the set of feasible time slots, with the lowest level of intrusiveness for one or more potential participants by:
determining a level of intrusiveness in a time slot by:
assigning a first weight based on a participant's attendance level to the meeting;
assigning a second weight based on a participant's booking availability priority;
performing a mathematical calculation with the assigned first weight on the participant's attendance level and the assigned second weight on the booking availability priority to obtain a calculated value;
storing the calculated value;
determining whether there are additional participants;
wherein in the event there are additional participants:
obtaining an additional calculated value for each additional participant using the process steps outlined above; and
wherein in the event there are no more additional participants:
performing a mathematical combination of the stored calculated values to obtain an intrusiveness value that indicates a level of scheduling conflict in the time slot; and
wherein from the set of feasible time slots, the time slot with the lowest intrusiveness value is used for scheduling the new meeting.

9. The article of claim 8, wherein the time range that bounds the set of feasible time slots is determined by an inversely proportional relationship to a level of urgency associated with the new meeting.

10. The article of claim 8, wherein the mathematical calculation is at least one of a multiplication and a subtraction; and
wherein in the event the mathematical calculation is a subtraction, the assigned first weight on the participant's attendance level is subtracted from the assigned second weight on the booking availability priority.

11. The article of claim 8, wherein the mathematical combination is a summation.

12. The article of claim 8, wherein the assigned first weight on a participant's attendance level is determined using ascending numeric values associated with one of the following sequences of qualifiers:
optional, required, and essential; and
spectator, decision-maker, and presenter/moderator.

13. The article of claim 8, wherein the assigned second weight value differs for a participant that is available and not scheduled for a conflicting meeting in the time slot, an optional participant in a conflicting meeting in the time slot or has a low priority booking in the time slot, a required participant in a conflicting meeting in the time slot or has a normal priority booking in the time slot, and an essential participant in a conflicting meeting in the time slot or has a high priority booking in the time slot.

14. A system for an electronic calendar and scheduling application, the system comprising:
one or more computing and communication devices in communication through a network;
wherein the one or more computing and communication devices are configured to:
determine a set of feasible time slots bounded by a time range;
determine a time slot, from the set of feasible time slots, with the lowest level of intrusiveness for one or more potential participants by the following:
determine a level of intrusiveness in a time slot by the following:
assign a first weight based on a participant's attendance level to the meeting;
assign a second weight based on a participant's booking availability priority;
perform a mathematical calculation with the assigned first weight on the participant's attendance level and the assigned second weight on the booking availability priority to obtain a calculated value;
store the calculated value;
determine whether there are additional participants;
wherein in the event there are additional participants:
obtain an additional calculated value for each additional participant using the process steps outlined above; and
wherein in the event there are no more additional participants:
perform a mathematical combination of the stored calculated values to obtain an intrusiveness value that indicates a level of scheduling conflict in the time slot; and
wherein from the set of feasible time slots, the time slot with the lowest intrusiveness value is used for scheduling the new meeting.

15. The system of claim 14, wherein the time range that bounds the set of feasible time slots is determined by an inversely proportional relationship to a level of urgency associated with the new meeting.

16. The system of claim 14, wherein the mathematical calculation is at least one of a multiplication and a subtraction; and
wherein in the event the mathematical calculation is a subtraction, the assigned first weight on the participant's attendance level is subtracted from the assigned second weight on the booking availability priority.

17. The system of claim 14, wherein the mathematical combination is a summation.

18. The system of claim 14, wherein the assigned first weight on a participant's attendance level is determined using ascending numeric values associated with one of the following sequences of qualifiers:
optional, required, and essential; and
spectator, decision-maker, and presenter/moderator.

19. The system of claim 14, wherein the assigned second weight value differs for a participant that is available and not scheduled for a conflicting meeting in the time slot, an optional participant in a conflicting meeting in the time slot or has a low priority booking in the time slot, a required participant in a conflicting meeting in the time slot or has a normal priority booking in the time slot, and an essential participant in a conflicting meeting in the time slot or has a high priority booking in the time slot.

20. The system of claim 14, wherein a graphical user interface is configured to provide a user and the one or more participants with an ability to redefine default values of meeting bookings and task bookings, and to provide visual indicators of time slot booking priorities.
